(19) United States
(12) Patent Application Publication
(10) Pub. No.: US 2016/0254000 A1
(43) Pub. Date: Sep. 1, 2016

(54) Automated Digital Agreement Attestation & Electronic Signature Execution via Speech-Recognition

(71) Applicant: Kevin Thomas Thalanany, Plymouth, MA (US)

(72) Inventor: Kevin Thomas Thalanany, Plymouth, MA (US)

(21) Appl. No.: 15/056,606

(22) Filed: Feb. 29, 2016

Related U.S. Application Data
(60) Provisional application No. 62/121,990, filed on Feb. 27, 2015.

(51) Int. Cl. G10L 17/00; G10L 17/24; G10L 15/26; H04L 29/06; H04L 9/32

(52) U.S. Cl. CPC G10L 17/005; H04L 63/0861; H04L 9/3247; G10L 15/265; G10L 17/24

(57) ABSTRACT

A voice-verified execution of agreement terms via an on-line system is described. The system facilitates performing a set of interactive operations with the signer. The operations include maintaining an electronic copy of an agreement including one or more terms for acceptance by the signer; receiving an indication of agreement to a term of the agreement; issuing a prompt to the signer for a vocal confirmation of consent to the term; receiving an electronically encoded vocal response of the signer to the prompt; decoding the electronically encoded vocal response to render a text response; comparing the text response to a stored acceptable response definition; and storing an electronic copy of an executed version of the agreement wherein the executed version includes: an indication of the term of the agreement and a digital voice encoded file corresponding to the electronically encoded vocal response.

### CROSS-REFERENCE TO RELATED APPLICATIONS

This patent application claims the benefit of U.S. Provisional Patent Application No. 62/121,990, filed Feb. 27, 2015, entitled “Automated Digital Agreement Attestation & Electronic Signature Execution via Speech-Recognition Enabled Internet-Based Telecommunications”, which is incorporated by reference herein in its entirety including any references therein.

### FIELD OF THE INVENTION

This invention generally relates to creating and validating an electronic signature for the purpose of affixing the electronic signature to a specified digital agreement, contract, estimate, or document.

### BACKGROUND OF THE INVENTION

As internet-based interactions expand both in scale and scope, so too is the need for legally binding corresponding electronic signatures and digital agreements. Since the enactment of the Electronic Signatures in Global and National Commerce Act (ESIGN, Pub.L. 106-229, 114 Stat. 464, Jun. 30, 2000, 15 U.S.C. ch. 96) ensured the validity and legal enforceability of contracts entered into electronically, there have been mechanisms for creating electronic signatures made available for the purposes of creating digital agreements compliant with this act.

Currently, executing electronic signatures typically requires an agreement to be converted into a digital format that is then transmitted to a third-party electronic signature service. The service authenticates the intended new signer's identity using a unique name and/or email address before permitting electronically signing the agreement Using the electronic signature service's system, the authenticated signer indicates consent to the agreement's terms and conditions, and after consent has been indicated by the signer, the electronic signature service affixes an electronic signature (formatted as “/s/john doe”) to the digital form of the agreement in a manner compliant with the ESIGN act.

Electronic signature Services primarily rely upon the signer retyping a legal name as a primary method of expressing consent and agreement before affixing an electronic signature to a digitally signed agreement. In place of the aforementioned electronic signature methodology, electronic signatures may alternatively be created by the new signer utilizing a stylus pen, a computer mouse, or even a fingertip to move across the touchscreen of the signer's device in a motion intended to replicate the signer's actual handwritten signature as an electronic signature.

Current means of creating electronic signatures, whilst valid and legally enforceable, lack the distinct uniqueness and material nature of the accredited handwritten signature. This inherent lack of verifiability in the current ways of producing electronic signatures is most evident in electronic signatures produced wherein the signer merely retypes the signer's name as the sole means of authorizing the electronic signature service to affix a legally enforceable electronic signature to the digital agreement. Even in instances where an electronic signature is created by the signer imitating the motion of the signer's handwritten signature upon the surface of a touchscreen using a mouse, stylus pen, or the signer's fingertip, the digitally recorded replica of the signer's handwritten signature seldom, if ever, resembles the signer's actual handwritten signature. Such poor replication of an actual signer's signature is due to, for example: an unavoidable amount of pixilation in converting the tactile motion into a digital image, a varying degree of tactile sensitivity and accuracy among a wide range of available touchscreen devices, and a signer's relatively unconditioned ability to replicate the signer's handwritten signature via the signer's fingertip on a touchscreen without the familiarized use of a conventional writing utensil. As a consequence, a high tolerance is needed for discrepancies between a signer's actual handwritten signature and the signer's electronically recorded/generated signature produced digitally. Because of this and the lack of verifiability in retyping an individual's name as means of electronic signature, there is considerable potential for unauthorized electronic signatures.

Electronic signatures have failed to garner the same widespread use and credibility in commerce as compared to handwritten signatures, in spite of the tremendous growth in internet-based interactions which heavily depend on electronic signatures due to the rapidity of transactions and the tendency for geographical separation between the agreement bearer and agreement signer. Apprehension towards reliance on electronic signatures largely exists due to the relative disadvantages discussed above regarding producing electronic signatures when compared to the long-established use of handwritten signatures. The disadvantages of current methods for producing electronic signatures can generally be summarized into one of two categories:
1. Reliance on a reduced degree of qualifying the signer's consent to agreement before affixing an electronic signature to a digital agreement for the sake of automation, and
2. An innate lack of verifiability in the electronic signature's digital format.
   Furthermore, handwritten signatures carry an additional source of reassurance stemming from availability of signature analysis (graphology) which can be used to validate authenticity and true ownership of a handwritten signature whereas electronic signatures lack any comparable means of signature authentication that utilizes biologically unique characteristics and/or the personal tendencies of the signer.

### BRIEF SUMMARY OF THE INVENTION

A system and method are described herein for performing voice-verified execution of agreement terms. The system comprises a processor, an interface for receiving electronically encoded spoken words of a signer to an agreement and a non-transitory computer readable medium including computer-executable instructions. The computer-executable instructions are executed by the processor to facilitate performing a set of interactive operations with the signer. The operations comprise maintaining an electronic copy of an agreement including one or more terms for acceptance by the signer. The operations further include receiving an indication of agreement to a term of the agreement. Importantly, the steps further include issuing a prompt to the signer for a vocal confirmation of consent to the term. Thereafter, the system receives an electronically encoded vocal response of the signer to the prompt. The system thereafter decodes the electronically encoded vocal response to render a text response and compares the text response to a stored acceptable response definition. The system stores an electronic copy of an executed version of the agreement wherein the executed version includes: an indication of the term of the agreement and a digital voice encoded file corresponding to the electronically encoded vocal response.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1A depicts a general arrangement between a user presenter/signer computer terminal and a server/database computer for carrying out the present invention;

FIG. 1B summarizes operations for carrying out a voice-validated electronic signature procedure in accordance with an exemplary embodiment;

FIG. 2 identifies content from a set of data fields associated with an agreement presenter (a.k.a. the user) and an agreement signer (a.k.a. the signor);

FIG. 3 is a flowchart outlining the process wherein the user of the system creates the digital agreement;

FIG. 4 is a flowchart outlining the process of the signer using the system to electronically sign the digital agreement created by the user;

FIG. 5 depicts the digital agreement as created by the user in the system's interface. The figure includes the stored vocal response, electronic signature, terms and conditions, singer's details, and the call log details corresponding to the automated phone call placed to the signer;

FIG. 6 depicts the online interface's welcome screen for beginning the electronic signature process for both the user and the signer;

FIG. 7 depicts the interface's user account access user account creation screen whereby the agreement creator can create an account or log into an existing account with all stored agreements associated with this specific user;

FIG. 8 is a screenshot of the system's interface depicting the required parameters for creating a unique account for creating agreements by a given user;

FIG. 9 depicts the main interface screen of the networked system wherein the user can create new digital agreements, view and edit pending agreements, view signed agreements, and view all designated signers;

FIG. 10 depicts the user form wherein the user must designate a unique identifier for the agreement about to be created;

FIG. 11 depicts the interface for the user to textually input the terms and conditions of the agreement;

FIG. 12 is a screenshot of the user form wherein the user may designate a specific signer as the intended signer by providing the system with the intended signer's name, email, and/or phone number;

FIG. 13 depicts the interface that the signer sees when accessing the networked system;

FIG. 14 is a screenshot of the online interface after the signer's identity has been authenticated as an intended signer, whereby the signer may view a list of digital agreements available to the signer and select a specific agreement to begin the voice-validated electronic signature process; and

FIG. 15 is a screenshot of the signer using the system's interface to confirm his or her intention to electronically sign a specific term or condition using the system's “voice validation” process wherein an automated phone call will be placed to the signer to capture the signer's vocal confirmation of agreement.

### DETAILED DESCRIPTION OF THE DRAWINGS

The computer-based system and method described herein is presented in the context of facilitating businesses automating a time-intensive process of executing employer-employee agreements established during the employee hiring process. Additionally, the described method and system's unique “voice-validated” electronic signature process produces a greater degree of verifiability in any of a wide variety of digitally-attested agreement. Thus, while especially applicable to executing employment agreements, the actual applicability of the described system and method is far more widespread.

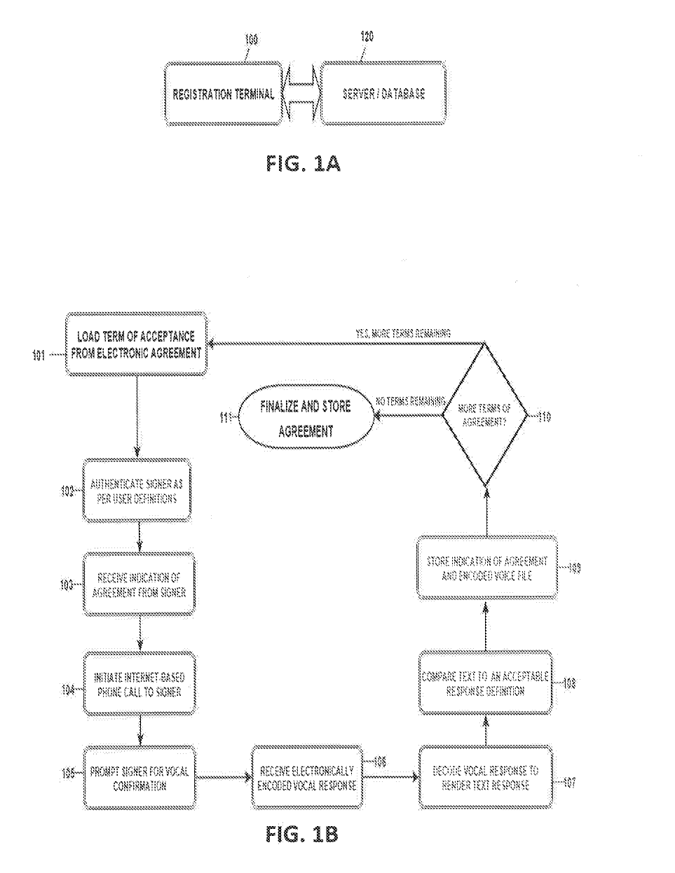

An Internet-based electronic signature system generally depicted with reference to FIG. 1A (including a registration terminal 100 and a server/database 120) is described herein that incorporates an audio recording of the intended signer's voice as protocol for voice-validated attestation system. The user (a.k.a. agreement presenter) of the invention specifies/stores both: (1) the terms and conditions of the digital agreement, and (2) the contact information of the intended signer/signers (a.k.a. agreement signer). FIG. 1B summarizes a set of operations for performing a voice-validated electronic signature procedure. The flowchart generally depicts a procedure flow associated with obtaining an authenticated: prompting the signer with user's predefined term/condition, authenticating the signer, validating the signer's vocal agreement through speech recognition, and finally affixing an electronic signature of the signer to that term/condition of the agreement.

The previously defined/stored digital agreement (block 101) is made available to the signer via the networked computer-based system's online interface. By way of example, an automated notification to the intended signer can be placed via SMS text or email by the system unless the digital agreement is to be publicly available to all as per the user's specifications. Access to the digital agreement is granted after the individual attempting to access the digital agreement presents identifying information that matches the contact information of the intended signer as per the user's definitions (e.g. name, email address, phone number and/or organization of the intended signer) referenced in block 102.

After the intended signer gains access to the digital agreement via the system's online interface, the intended signer may select a term/condition to begin agreement execution once the system receives an indication of agreement from the signer 103. The system then initiates a software-directed internet-based outbound phone call to the phone number associated with the intended signer as in block 104. During this system automated and recorded phone call, the system uses speech recognition enabled text-to-speech conversion to verbally recite the selected term/condition of the digital agreement as per the user-defined text of that term/condition as in block 105.

After reading the term/condition to the signer, the system (block 105) then prompts the intended signer to restate (or agree to) the term/condition as read by the system. The system records the signer's vocal confirmation of agreement and receives the electronically encoded vocal response 106. The recorded sound bite of the signer's vocal agreement is then analyzed via speech-to-text recognition and the system decodes the signer's vocal response to render text response 107. The rendered text is then compared to the actual text of the term/condition as defined by the user of the system during 108. If there is an acceptable level of accuracy between the speech-to-text recognized text of the recorded sound bite and the user-defined text of the terms and conditions, the digital agreement is then rendered as “voice validated” and the signer's electronic signature, sound bite of vocal agreement, and the phone call log details are affixed to the digital agreement for that specific term/condition during 109. The system will then proceed to the next term/condition requiring an electronic signature and prompt the signer for vocal agreement from the signer. If an acceptable level of accuracy cannot be established by the system whilst comparing the rendered text from the signer's vocal confirmation to the user-defined term, another software-directed interact-based phone call will be placed to the user of the invention during which the last recorded sound bite of the signer's vocal agreement will be played for the user to either manually confirm an acceptable level of accuracy for that sound bite or to reject the sound bite and request a new sound bite of vocal agreement from the intended signer.

After all of the terms/conditions requesting voice-validated electronic signatures have been agreed to by the intended signer, the digital agreement is sent via email to the user of the invention and the signer. The digital agreement is additionally saved in the system's server with all of the corresponding electronic signatures, sound bites of vocal agreement, and phone call log details of automated recorded phone call for verification purposes.

The described networked/computer-based method and system, including the particular messaging between users/servers, provide a more reliable electronic proxy for a written signature and offer a high level of confidence of authenticity that is normally associated with the inherent identifiability of handwritten signatures. This is accomplished by the described method and system's incorporation of the signer's biologically unique voice for the purposes of creating electronic signatures with a greater degree of distinctiveness and evidenced tangible human engagement compared to the previously described available electronic signature services. Additionally, this invention's voice validation process provides more verifiable evidence of the signer's consent through recorded audio of the signer's stated agreement and call log details of the automated recorded phone call placed to the signer's phone. The invention performs this “voice-validation” process as part of the electronic signature process in a manner that is compliant with the stipulations of the federal ESIGN act.

The described electronic signature acquisition and attribution process described herein provides a mechanism for signers to an agreement expressing consent wherein there is a greater assurance of the signer having actually read and understood the terms and conditions of the agreement by having the signer vocally recite the terms and conditions as prompted before affixing an electronic signature to the agreement. The electronic signature acquisition/attribution mechanism and methodology reduces the need for an agreement to be administered by a human representative of the contract presenter to ensure that the signer has in fact read/understood all the requested terms as the system's online interface, and use of text-to-speech will prompt the signer and the system's speech-to-text will confirm that the signer is in fact stating agreement to the selected term/condition.

The described networked/computer-based system provides an internet-based electronic signature mechanism and methodology that is superior in terms of verifiability and credibility to current electronic signatures and is more convenient than the handwritten signature, while remaining viable for all types of human interactions that call for a legally enforceable agreement to be formed.

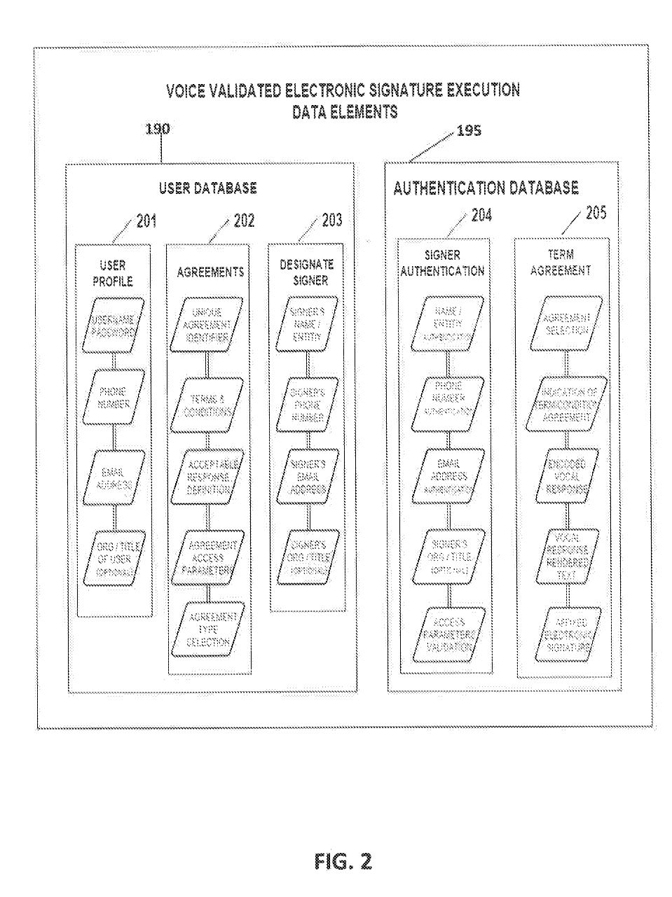

Turning to FIG. 2, a set of data fields are identified that are maintained, by the application and database server 120, for an agreement presenter (a.k.a. the user) and an agreement signer (a.k.a. the signor) for carrying out the steps, summarized above with reference to FIG. 2B, requiring data inputs and interaction with the networked database in the electronic signature process such as: creating a user profile, creating the digital agreement in the system, designating an intended signer, verifying the intended signer, and affixing an electronic signature of the signer. In order for the procedure summarized in FIG. 1B to be executed between the agreement presenter (i.e. the user)—summarized by data contained in a user record 190 and the agreement signer represented in a signer record 195 (i.e. the signer of the agreement expressing consent to the agreement terms) there are several key data fields required by both parties as outlined in FIG. 2. Before speech-recognition based electronic signing can occur, the user must set up a user profile, create a digital agreement, and may optionally specify an intended signer to be stored in the system's user database 190. in order to create a user profile, the user must provide his or her name, a desired password, phone number, email address, and title (optional) as summarized in an exemplary user profile data structure 201.

After the account is established, the user creates a digital agreement to be electronically signed by designated signers via the system user interface (described herein below in detail). An exemplary set of stored data corresponding to such digital agreements is summarized in an exemplary agreement data structure 202. As shown in the data structure 202, creating the digital agreement requires a name for the agreement, type of agreement (i.e. contract, estimate, appraisal, agreement, etc.), any desired logos or images, and the text of each of the terms/conditions constituting the digital agreement. After the text of the terms/conditions have been inputted, the user may specify which of the terms/conditions are to require vocal confirmation from the signer if not all of the terms/conditions.

In accordance with an exemplary designated signer structure 203, the user may specify an intended signer for the digital agreement by providing the system with a combination of the intended signer's name, phone number, email address, and organization to be used as a means of authenticating the intended signer prior to granting access to the intended signer.

Additionally, in accordance with a further element of the agreement structure 202, the user may create (and store) a unique identifier for the agreement that the signer must provide in order to gain access to the agreement. After the user has provided all of the system required data, the digital agreement is available to the intended signer through the online interface.

Turning to the contents of an exemplary signer authentication database 195, in accordance with an exemplary signer authentication data structure 204, the signer provides a name, an email address, a phone number, an access code and/or a unique identifier for the agreement. If the identified signer's credentials match as the intended signer per the user (i.e. are authenticated), then the signer may proceed to electronically sign the agreement.

A term agreement structure 205 maintains a record of a signer's agreement to presented agreement terms. Thus, during a process of obtaining a signer's agreement to individually presented terms/conditions of a particular presented agreement, the signer provides the system with a selection of an agreement term/condition, an indication of agreement and the signer's vocal response to the presented agreement term. the agreement signer provides the identified elements of the term agreement structure 205 during the process of agreeing to the term/condition. The system stores, in the structure 205 that includes: the agreed term text (or reference thereto), indication of agreement (e.g., record of checked box), a digitally encoded copy of the spoken audio answer of the signer indicating agreement to the term, the rendered text from the signer's vocal response, the phone call log details of the automated internet-based phone call placed to the signer (not shown in the drawing), and an affixed electronic signature. The fields of the structure 205 are exemplary in nature and not intended to indicate an essential requirement of each of the identified contents of the structure 205 described herein.

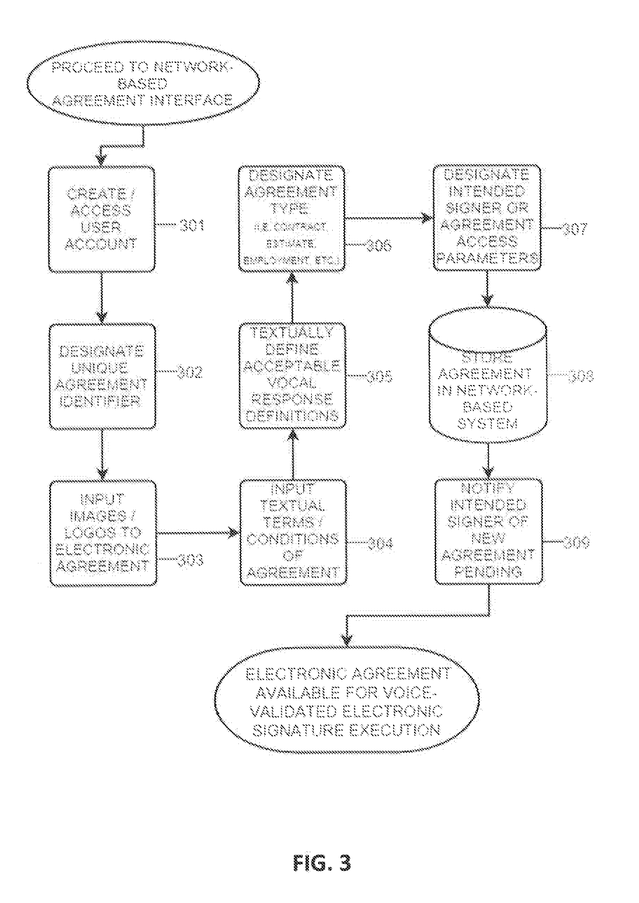

Turning to FIG. 3, a flowchart summarizes an electronic/computer-implemented procedure wherein a user of the system creates and publishes a new digital agreement. The user defines the terms/conditions of the contract, agreement, estimate, or document that the user would like to have electronically signed by a signer via the system. The new digital agreement may be customized to the user's needs and preferences, but it must follow a format via the system's online interface in order for the system to be able to “voice-validate” the user's digital agreement. The flowchart presented in FIG. 3 outlines an example where the user requires an electronic signature from a known and specific signer.

During 301, the agreement presenter creates an account on the voice validated digital agreement system's online interface. The agreement bearer must specify the name, organization, phone number, email address under which the agreement is to be created. During 302, the agreement presenter designates an alphanumeric unique identifier or name for the digital agreement requesting voice validated electronic signature. During 303, the agreement presenter may (optionally) upload any logos, images, or scanned images of documents affix to the digital agreement. During 304, the user inputs the text of each of the terms and conditions constituting the contract, agreement, estimate or document requiring a voice validated electronic signature. After the user inputs the textual terms/conditions, during 305 the user defines an acceptable response definition that the system uses as a basis for acceptability of the rendered text of the signer's decoded vocal response in order for the system to accept the signer's vocal confirmation as confirmation of agreement and affix an electronic signature to the agreement. During 306, the user designates the type of digital agreement that is being uploaded into the system (e.g. services; goods contract, employment agreement, project estimate, etc.

During 307, the system enables the user to create a digital agreement to be made available to potential signers online through the voice validated electronic signature system's online interface in one of two modalities. In a first modality, where the agreement is “available only to a designated signer” the user is prompted to enter the details of a particular intended recipient of the agreement as defined by the data elements (outlined in FIG. 2 element 203). In the second modality of agreement access by a signer, the agreement may be accessed by retrieval through user-defined unique alphanumeric agreement identifier.

During 308, the system compiles the digital agreement, which includes the specifications and inputs provided by the user, and stores the digital agreement in the network-based system. In an exemplary case, the specified designation of a signer is the default modality and the only modality wherein the system can validate the identity of the signer as an authorized signer of the digital agreement.

During 309, the system sends notification via email/SMS text message to the intended signer (if specified) and a corresponding URI, address to access the digital agreement in the networked system.

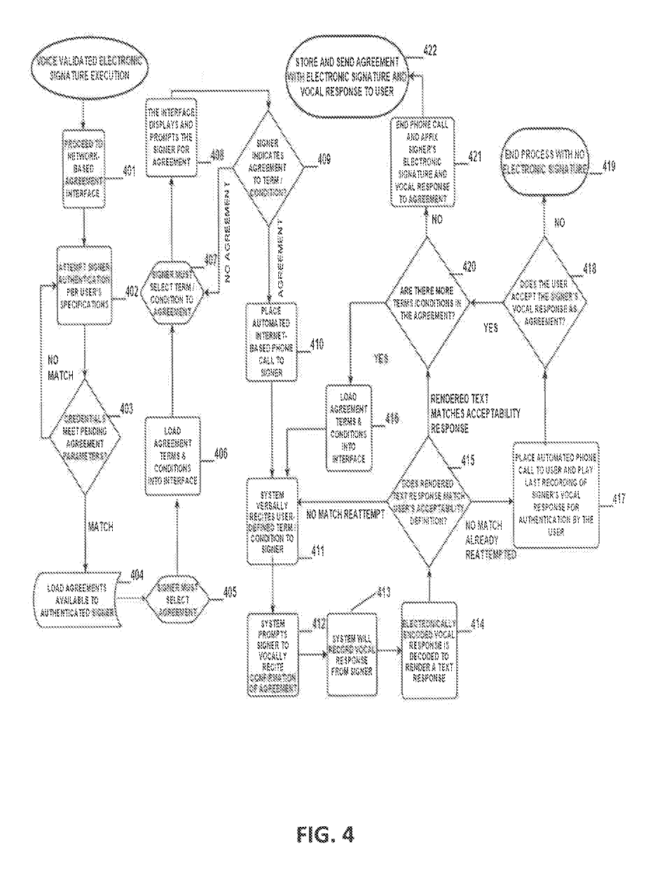

Turning to FIG. 4, a flowchart summarizes operations carried out by the system to electronically sign the document previously created during the operations summarized in FIG. 3. FIG. 4 summarizes a process of the signer using the system to electronically sign the digital agreement created by the user. During the outlined process, the system verifies the signer's identity, prompts the signer to indicate agreement, places a software-directed internet-based phone call to the signer, records the signer's vocal agreement, analyzes the vocal agreement for accuracy to the user's predefined term/condition, and affixes the signer's electronic signature to the digital agreement. This process also includes a sub process (415,417,418) in which the user of the system is able to manually approve a vocal agreement from the signer as matching the term/condition if the system's speech recognition cannot confirm the signer's vocal agreement as matching the user's predefined term/condition automatically.

During 401, the agreement signer navigates to the voice validated electronic signature service's online interface or by utilizing the corresponding URI, address sent by the system if the agreement presenter designated an intended signer.

During 402, the signer provides information through the system's online interface to access an agreement available to the signer per the user's specifications. The signer provides the system with the signer's full name, email address, and phone number and consent to be recorded. Only after providing the login credentials or an agreement's unique identifier in order to authenticate access, can the signer use the voice validation system interface to electronically sign the available digital agreement.

After authenticating the signer as the user's intended signer during 403, control passes to 404 wherein the system displays all digital agreements available to the signer awaiting electronic signatures. Next, during 405, the signer selects the contract to begin the voice validated electronic signature process, and during 406 the system loads the digital agreement as per the user's specifications.

Thereafter, during 407, the signer selects the term or condition to begin the voice-validation process. All terms and conditions that require voice-validation as per the user (presenter of the agreement) must be selected and individually voice-validated by the signer. After a term/condition has been selected by the signer, during 408 the system displays the term/condition on the system's online interface during and the system prompts the signer for an indication of agreement. If the signer chooses to agree to the selected term/condition of the agreement, the signer may then proceed to electronically sign the term/condition otherwise the signer will be redirected back to select another term/condition to indicate agreement during 409.

After the signer has indicated agreement to the selected term/condition on the system's online interface, the system places a software-directed internet-based phone call to the signer during 410. Once the phone call has been received by the signer, the system will utilize text-to-speech conversion and vocally recite the term/condition as defined by the user during 411. During 412, the signer is vocally prompted by the software-directed internee-based phone call to vocally recite the term/condition exactly as it was spoken to the signer. After the signer has been prompted to vocally confirm agreement, the system records audio of the signer's vocal response during 413.

Thereafter, during 414, the electronically digitally encoded sound recording of the signer's vocal confirmation is then processed by the system's speech-to-text converter to render a text response of the signer's vocal confirmation. Next, during 415, the system's speech recognition generated text from the signer's vocal recital of the term/condition is then compared to the predefined text of the term/condition as defined by the user of the system with any of 2 general outcomes as follows:

1. The signer's electronically encoded response renders a text response that meets the user's acceptable response definition for the user-defined term/condition. In which case, control proceeds from 415 to 420 (described herein below).

2. The signer's electronically encoded response renders a text response that does not meet the user-defined acceptable response definition for the user-defined term/condition. In which case, control passes from 415 to either 411 or 417 based upon whether the system has already reattempted to receive the signer's electronically encoded vocal response converted to rendered text that did not meet the user's acceptability definition.

During 415, if there is an adequate level of correspondence established by the system between the predefined term/condition and the resultant text from the signer's vocal response, then control passes to 420 to determine whether additional terms/conditions require voice validation. During 420, if there are terms/conditions remaining requiring “voice-validation” the system will proceed to the next term/condition requiring validation by passing control from operation block 420 to operation block 416. However, if all terms/conditions requiring voice-validation as per the user have already been agreed to by the signer, then control passes from 420 to operation 421 wherein the system ends the phone call with the signer and proceeds to affix an electronic signature to the digital agreement.

After all terms/conditions have been “voice-validated” by the signer, the digital agreement, sound bite, and electronic signature are saved in the networked system (e.g. committed to an online agreement database). Details of the automated phone call are also saved in the system (i.e. the time the call was placed, the number the call was placed to, and the duration of the phone call are all saved as the phone call log) agreement database for further verification purposes, and the voice-validation process is complete for this digital agreement 422.

Returning to 415, and in particular the “validation failure case”, the system will attempt to successfully complete voice validation up to a specified maximum number of times. After attempting to collect a vocal confirmation from the signer with rendered text from the signer's vocal confirmation that does not meet the user's acceptability definition for the user-defined term/condition for a maximum number of attempts, the system will attempt to approve the signer's vocal agreement through the user in accordance with operations corresponding to blocks 417 and 419 (described below).

Thus, if, during 415, a maximum number of attempts has not been reached, then control of the voice validation operation returns from 415 to 411 wherein the system attempts to collect another vocal recital from the signer. However, in the case where speech recognition failed and a maximum number of attempts has been reached, then control passes from 415 to 417 (described herein below).

With reference to 417, if, during 414, the maximum number attempts have been made without an adequate level of accuracy established by the system between the predefined term/condition and the resultant text from the signer's vocal statement, the system ends the internet-based phone call with the signer and attempts to receive acceptance for electronically encoded vocal response from the user of the system in accordance with operation block. During the phone call to the user, the system will play the last recorded sound bite of the signer's vocal agreement. Next, during 418, the system prompts the user to either accept or reject this sound bite as vocal confirmation from the signer for the user-defined term/condition.

If the user accepts the sound bite, then control passes from 418 to 420 wherein the system determines whether additional terms for the agreement remain to be signed/verified. Thus, at 420, if no further terms need attention, control passes to 421 wherein the system ends the phone call with the user and affixes an electronic signature for the signer to the digital agreement for that term/condition. If additional terms/conditions need attention by the system, then control passes to 416 to prompt the signer with the next term/condition.

With continued reference to 418, if the user does not accept the sound bite, then the system ends the phone call and electronic signature process for both the signer and the user in accordance with 419. Notification will be sent to the signer and user of no agreement being established and that the digital agreement is still awaiting an electronic signature from the signer.

After all terms and conditions of the digital agreement have been vocally confirmed by the signer, during 422 the digital agreement is saved with the signer's electronically encoded vocal response, phone call log details, and electronic signature; a voice validated digital agreement has been created, completed, and signed by the signer in an e-sign act-compliant manner.

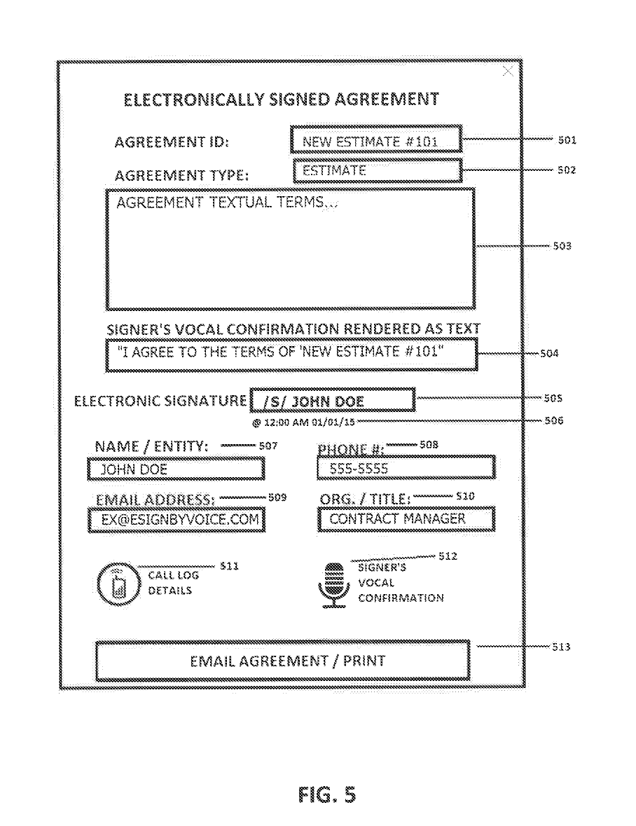

Turning to FIG. 5, an exemplary “voice-validated” electronically-signed agreement is illustratively depicted with various elements of the agreement. The agreement's unique alphanumeric identifier is shown in 501. The agreement type as specified by the user is shown in 502. The terms/conditions of the agreement are displayed in 503. The rendered text from the signer's electronically encoded vocal response is shown in 504. The signer's electronic signature is shown in 505. The date and time of the signer electronically signing the agreement through the “voice-validation” process is shown in 506. The name/entity of the signer is stored in 507 of the agreement. The phone number utilized for receiving the electronically encoded vocal response is depicted in 508. The signer's email address used in the authentication process is depicted in 509. The organization/title of the signer is shown in 510 of the image. The call log details of the internet-based phone call placed to the signer to capture the signer's electronically encoded vocal response is affixed to the agreement 511. The signer's electronically encoded vocal response is affixed to the digital agreement 512. The digital agreement on the system's networked interface allows the digital agreement to be printed, without the electronically encoded vocal response, or entailed with the vocal response included 513.

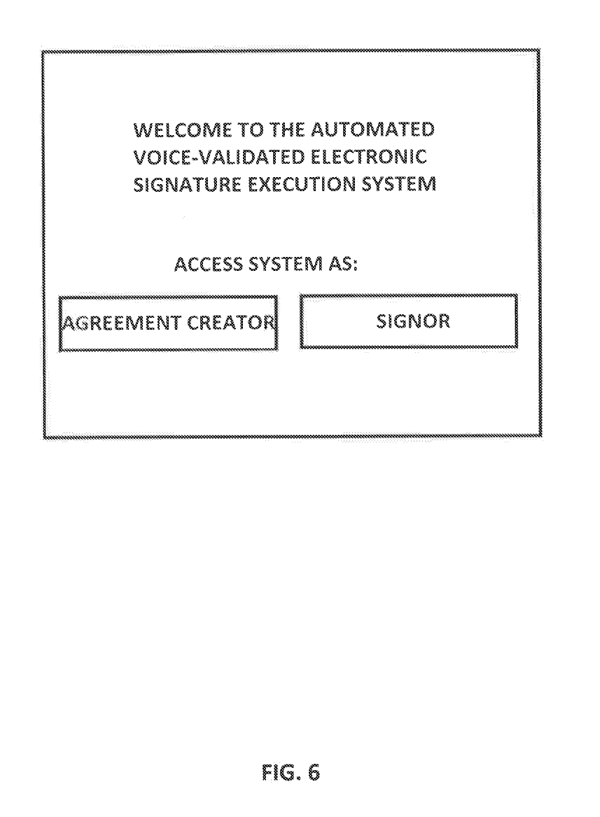

FIG. 6 depicts the online interface's welcome screen for beginning the electronic signature process for both the user and the signer

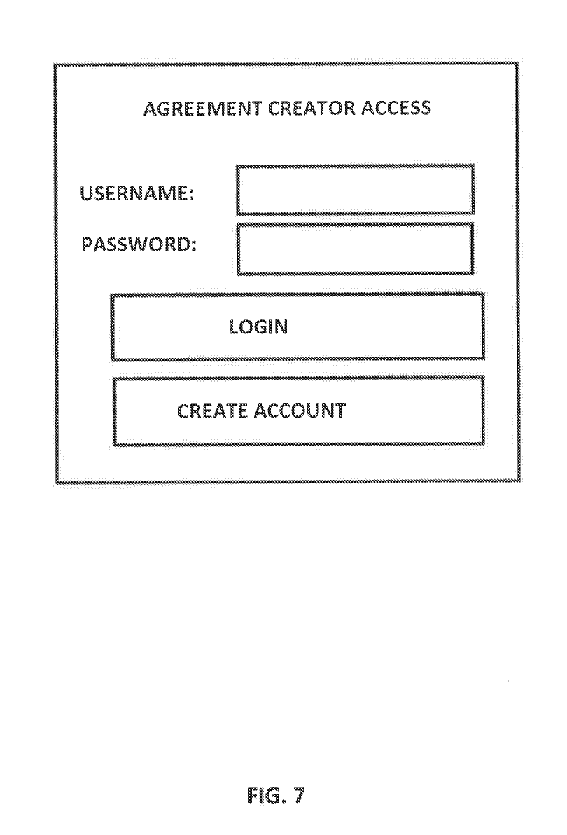

FIG. 7 depicts the interface's user account access/user account creation screen whereby the agreement creator can create an account or log into an existing account with all stored agreements associated with this specific user

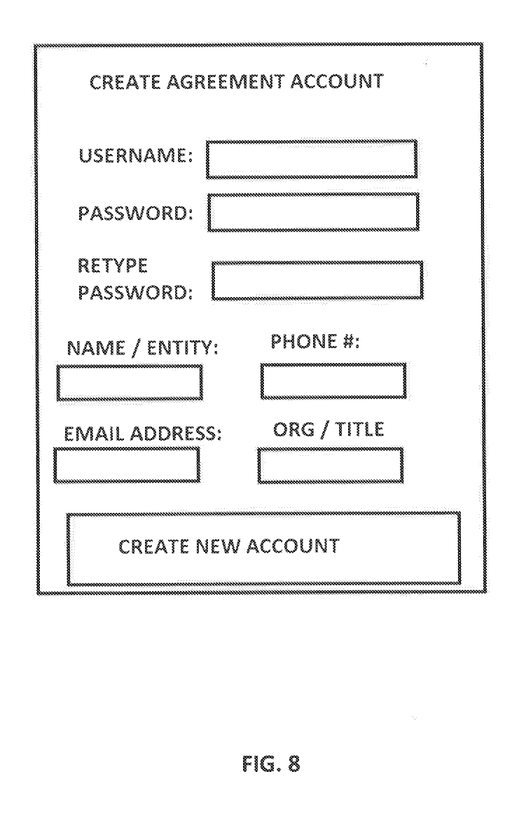

FIG. 8 is a screenshot of the system's interface depicting the required parameters for creating a unique account for creating agreements by a given user.

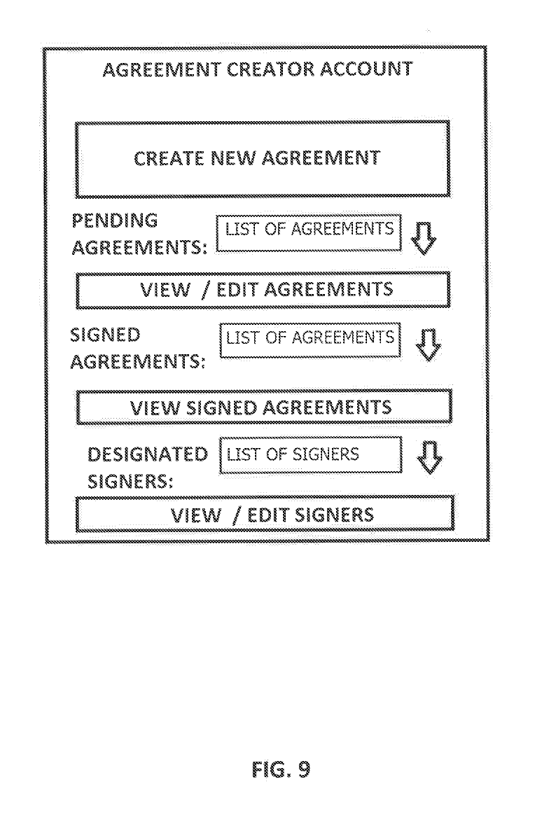

FIG. 9 depicts the main interface screen of the networked system wherein the user can create new digital agreements, view and edit pending agreements, view signed agreements, and view all designated signers.

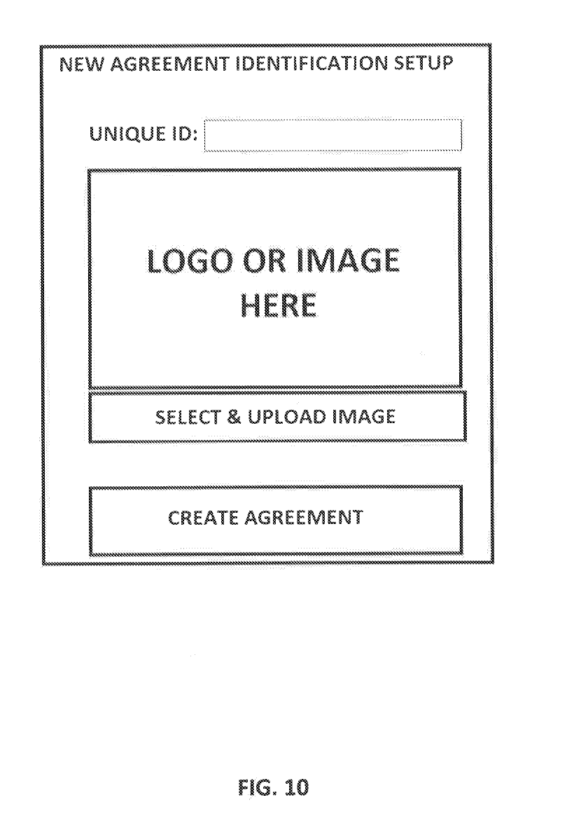

FIG. 10 depicts the user form wherein the user must designate a unique identifier for the agreement about to be created. The identifier is used to store and retrieve digital agreements in the networked system and must be established in this step. The user may optionally upload a logo or image in this user form to attach to the agreement.

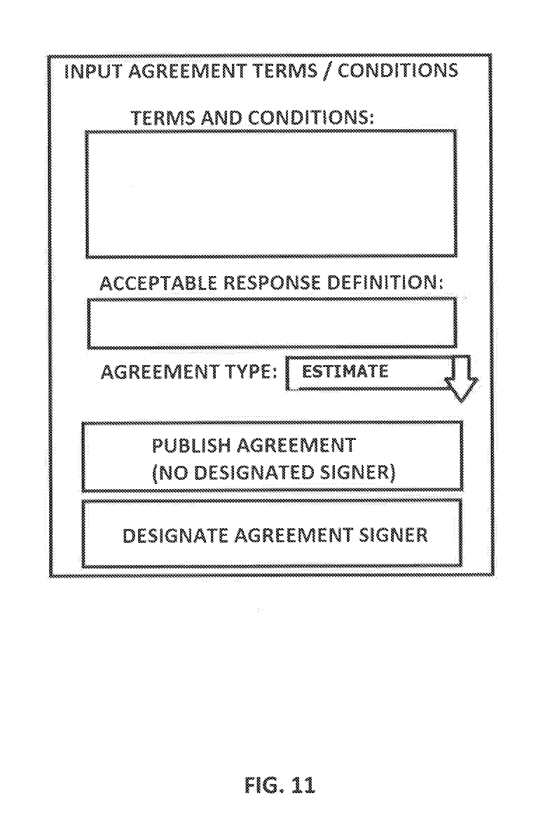

FIG. 11 depicts the interface for the user to textually input the terms and conditions of the agreement. This interface requires the user to textually define an acceptable response definition. This response definition is the text that the system will use as the basis for authenticating the signer's vocal confirmation of agreement using the decoded text rendered from the signer's electronically encoded vocal confirmation.

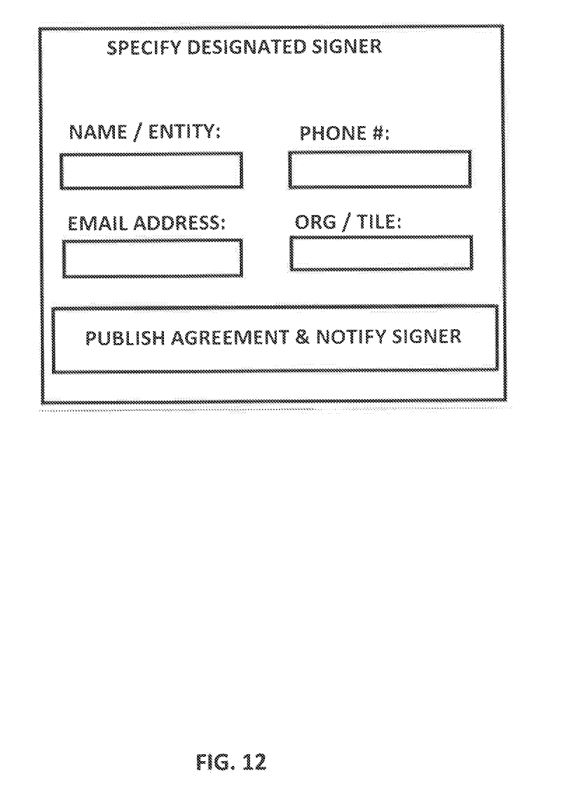

FIG. 12 is a screenshot of the user form wherein the user may designate a specific signer as the intended signer by providing the system with the intended signer's name, email, and/or phone number.

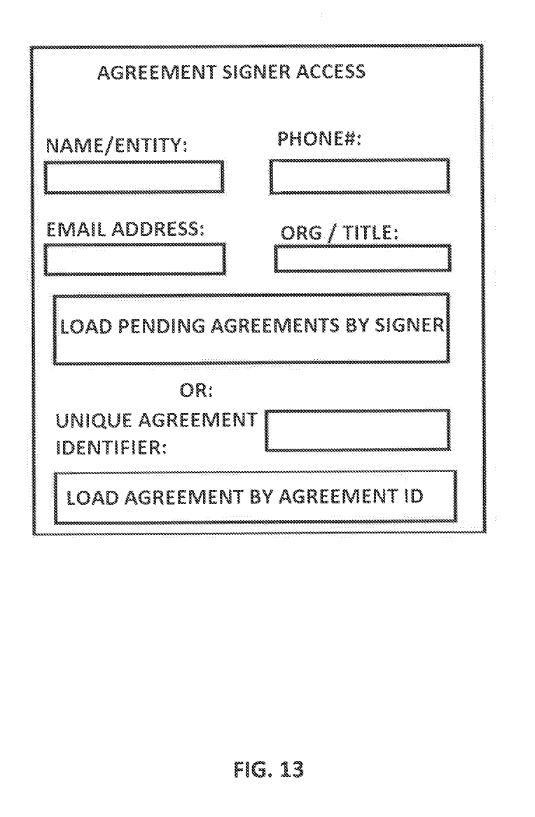

FIG. 13 depicts the interface that the signer sees when accessing the networked system. The signer may proceed to an available agreement pending electronic signature by either providing the interface with the signer's details of identity or by providing the interface with the desired agreement's unique alphanumeric identification.

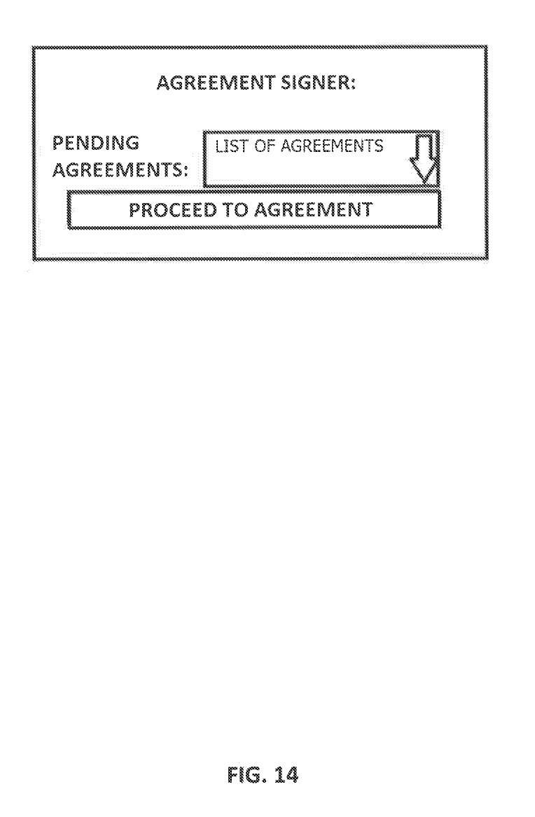

FIG. 14 is a screenshot of the online interface after the signer's identity has been authenticated as an intended signer, whereby the signer may view a list of digital agreements available to the signer and select a specific agreement to begin the voice-validated electronic signature process.

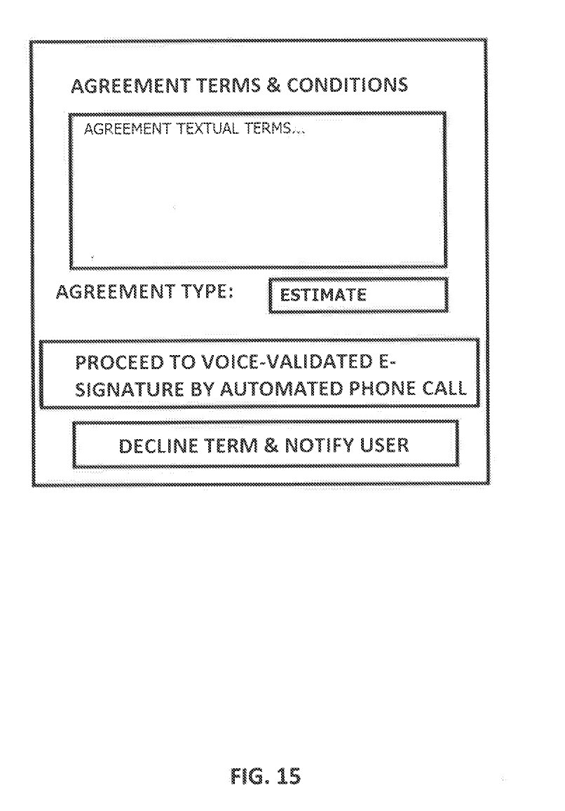

FIG. 15 is a screenshot of the signer using the system's interface to confirm his or her intention to electronically sign a specific term or condition using the system's “voice validation” process wherein an automated phone call will be placed to the signer to capture the signer's vocal confirmation of agreement.

It will thus be appreciated that the described system and method allows for reliable execution of agreements including potentially multiple terms of agreement via on-line and telephonic communications channels. It will also be appreciated, however, that the foregoing methods and implementations are merely examples of the inventive principles, and that these illustrate only exemplary structures and techniques.

It is thus contemplated that other implementations of the invention may differ in detail from foregoing examples. As such, all references to the invention are intended to reference particular examples of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A networked system for performing voice-verified execution of agreement terms, the system comprising:
a processor;
an interface for receiving electronically encoded spoken words of a signer to an agreement;
a non-transitory computer readable medium including computer-executable instructions that, when executed by the processor, facilitate performing a set of interactive operations with the signer, the operations comprising:
maintaining an electronic copy of an agreement including one or more terms for acceptance by the signer;
receiving an indication of agreement to a term of the agreement;
issuing a prompt to the signer for a vocal confirmation of consent to the term;
receiving an electronically encoded vocal response of the signer to the prompt;
decoding the electronically encoded vocal response to render a text response;
comparing the text response to a stored acceptable response definition; and
storing an electronic copy of an executed version of the agreement wherein the executed version includes: an indication of the term of the agreement and a digital voice encoded file corresponding to the electronically encoded vocal response.

2. The system of claim 1 wherein the voice-verified execution of agreement terms are executed by a system utilizing:
an internet-based automated phone call placed to the signer for the purpose of receiving electronically encoded spoken words;
receiving an indication of consent through the signer's phone;
receiving electronically encoded spoken words of a signer.

3. The system of claim 1 wherein the voice-verified execution of agreement terms utilizes storing an electronic copy of an executed version of the agreement which includes a digital voice encoded file corresponding to the electronically encoded vocal response for the purpose of providing the user with a biometric signature of agreement based on the inherent biological uniqueness of the signer's vocal response.

4. The system of claim 2 wherein the system is further configured by computer-executable instructions that are executed by the system to perform the further operation of authenticating the identity of an intended signer through an automated phone call placed to the unique phone number associated with the intended signer, the authenticating operation comprising storing corresponding call log details.

5. The system of claim 1 wherein the voice-verified execution of agreement terms are executed by a system utilizing the signer's electronic-device's built-in audio-visual recording device to perform the operations of:
receiving electronically encoded spoken words;
receiving an indication of consent through the signer's electronic device; and
receiving electronically encoded spoken words of a signer.

6. The system of claim 1 wherein the voice-verified execution of agreement terms are automated with the signer, the operations comprising:
decoding the user's electronically encoded textual terms and conditions to render an electronically vocalized response;
issuing a prompt based on the signer's indication of consent;
receiving an electronically encoded vocal response of the signer to the prompt;
decoding the electronically encoded vocal response to render a text response;
comparing the text response to a stored acceptable response definition; and
affixing an electronic signature of the signer to the digital agreement;
storing an electronic copy of an executed version of the agreement wherein the executed version includes: an indication of the term of the agreement and a digital voice encoded file corresponding to the electronically encoded vocal response.
